(19) United States
(12) Patent Application Publication
(10) Pub. No.: US 2016/0093859 A1
(43) Pub. Date: Mar. 31, 2016

(54) ENERGY STORAGE DEVICE

(71) Applicant: GS Yuasa International Ltd., Kyoto-shi (JP)

(72) Inventors: Kazuki KAWAGUCHI, Kyoto (JP); Masashi TAKANO, Kyoto (JP); Taro YAMAFUKU, Kyoto (JP); Masaki MASUDA, Kyoto (JP)

(21) Appl. No.: 14/863,956

(22) Filed: Sep. 24, 2015

(30) Foreign Application Priority Data
Sep. 29, 2014 (JP) 2014-198067
Aug. 31, 2015 (JP) 2015-170999

(51) Int. Cl. H01M 2/16

(52) U.S. Cl. CPC H01M 2/1673

(57) ABSTRACT

An energy storage device includes: an electrode having a composite layer formed by applying a composite directly or indirectly onto a substrate and a non-applied portion, onto which the composite is not applied; and a separator layered on the electrode to face the composite layer. Here, a drawn area is formed in at least. a part of the non-applied portion, and an intermediate layer is interposed at least between the drawn area and the composite layer.

### CROSS-REFERENCE TO RELATED APPLICATIONS

This application claims the benefit of Japanese patent applications No. 2014-198067, filed on Sep. 29, 2014, and No. 2015-170999, filed on Aug. 31, 2015, which are incorporated by reference.

### FIELD

The present invention relates to an energy storage device provided with an electrode and a separator.

### BACKGROUND

A lithium ion battery typifying an energy storage device is provided with a layered product, in which a positive electrode and a negative electrode (hereinafter they may be collectively referred to as “electrodes”) are layered via a separator. Here, a manufacturing process for an electrode for a lithium ion battery includes: a process for applying a positive composite or a negative composite (hereinafter they may be simply referred to as a “composite”) to a belt-like substrate (i.e., current collector) so as to form a composite layer; and a pressing process for increasing a composite density. At this time, the applied surface of the substrate is drawn under pressure in the pressing process. As a result, a difference in size in a longitudinal direction (i.e., an MD direction) occurs between the composite layer present on the substrate and a non-applied portion present at an end, and therefore, the electrode may be curved toward the non-applied portion. If the electrode is curved, the electrode and the separator are positionally shifted when they are layered one on another, resulting in the contact between the positive electrode and the negative electrode, thereby causing short-circuiting. Moreover, the curved electrode is wound up by a winder, thereby losing the balance of tensile force or causing a fracture of the electrode particularly in a widthwise direction.

In view of the above, in order to prevent the electrode from being curved, the non-applied portion of the substrate, at which the composite is not applied, is drawn, so that balance is kept between the non-applied portion and the composite layer, to which the co site is applied, followed by drawing. However, if the non-applied portion of the substrate is drawn when the substrate and the composite are not sufficiently brought into tight contact with each other, a stress generated by drawing is transmitted to the composite layer, and then, the composite layer is peeled off from a side near the non-applied portion, to possibly slip off. In view of this, in forming the electrode, it is necessary to contrive a scheme to prevent an adverse influence of drawing at the non-applied portion from being exerted on the composite layer.

There have been proposed some techniques for preventing the slippage of the composite layer in the conventional lithium ion battery. In order to prevent an active material layer from peeling off from a substrate, one example is a lithium ion battery in which an alumina containing layer containing γ-type alumina particles is formed on an electrode (see, for example, Japanese Patent Application Laid-open No. 2012-74359).

Alternatively, another example is an electrode for a lithium ion battery, in which a short-circuiting preventing layer is formed between a composite layer and a non-applied portion at a positive electrode (see, for example, Japanese Patent Application Laid-open No. 2013-51040). According to Japanese Patent Application Laid-open No. 2013-51040, a short-circuiting preventing layer is disposed in a power generating element obtained by winding a layered product including a positive electrode, a separator, and a negative electrode so as to prevent the non-applied portion of the positive electrode from facing the negative electrode, which otherwise induces short-circuiting.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The lithium ion batteries disclosed in Japanese Patent Application Laid-open Nos. 2012-74359 and 2013-51040 do not study the slippage of a composite layer that is possibly caused by a drawing process of a non-applied portion of an electrode. Therefore, the conventional technique relating to the electrode for the lithium ion battery has not disclosed a technique for preventing a composite layer from peeling off due to a drawing process of a non-applied portion of an electrode.

An object of the present invention is to provide an energy storage device with high quality that suppresses the peeling-off and slippage of a composite layer from a substrate of an electrode while suppressing the curve of an electrode in manufacturing an energy storage device such as a lithium ion battery.

An energy storage device according to an aspect of the present invention includes: an electrode having a composite layer formed by applying a composite directly or indirectly onto a substrate and a non-applied portion, onto which the composite is not applied; and a separator layered on the electrode to face the composite layer, wherein a drawn area is formed in at least a part of the non-applied portion, and an intermediate layer is interposed at least between the drawn area and the composite layer.

### BRIEF DESCRIPTION OF DRAWINGS

The foregoing and other features of the present invention will become apparent from the following description and drawings of an illustrative embodiment of the invention in which:

FIG. 1 is a partially cut-out perspective view, showing a lithium ion battery.

FIG. 2 is a perspective view showing a power generating element housed in a battery case in the lithium ion battery shown in FIG. 1.

FIG. 3 is a cross-sectional view schematically showing the configuration of the power generating element.

FIG. 4 is a plan view schematically showing the configuration of a positive electrode for the lithium ion battery.

FIG. 5 is a cross-sectional view schematically showing the configuration of a positive electrode in a first embodiment.

FIG. 6 is a cross-sectional view schematically showing the configuration of a positive electrode in a second embodiment.

### DESCRIPTION OF EMBODIMENTS

An energy storage device according to an aspect of the present invention includes: an electrode having a composite layer formed by applying a composite directly or indirectly onto a substrate and a non-applied portion, onto which the composite is not applied; and a separator layered on the electrode to face the composite layer, wherein a drawn area (stretched area) is formed in at least a part of the non-applied portion, and an intermediate layer is interposed at least between the drawn area and the composite layer.

As described above, it is construed that the slippage of the composite layer from the substrate is caused by an influence by a rolling process to the non-applied portion of the substrate in order to prevent an electrode from being curved in manufacturing the electrode. In view of this, the present inventors earnestly studied and succeeded in devising a layer structure of an area from the non-applied portion to the composite layer so as to subject. the non-applied portion to a rolling process while effectively suppressing the peeling-off and slippage of the composite layer.

Specifically, according to the energy storage device having the present configuration, the drawn area is formed in at least a part of the non-applied portion, on which no composite is applied, on the substrate, and further, the intermediate layer is interposed at least between the drawn area and the composite layer. As a consequence, a stress generated in the drawn area proceeds toward the composite layer through the intermediate layer all the time. Therefore, the stress generated in the drawn area does not reach the composite layer or is alleviated through the intermediate layer even if the stress reaches the composite layer. In this manner, the energy storage device having the present configuration can effectively suppress the peeling-off and slippage of the composite layer from the substrate by interposing the intermediate layer at least between the drawn area and the composite layer.

In the energy storage device according to an aspect of the present invention, it is preferable that the intermediate layer include an exposed portion that exists at least between the drawn area and the composite layer, and a non-exposed portion that exists under the composite layer.

According to the energy storage device having the present. configuration, the intermediate layer includes the exposed portion that singly exists at least between the drawn area and the composite layer, and the non-exposed portion. that exists under the composite layer Consequently, the intermediate layer is disposed so as to partly intrude under the composite layer between the drawn area and the composite layer. Thus, the intermediate layer exists in such a manner as to be brought into contact with a transmission path of the stress generated in the drawn. area, thereby more effectively suppressing the peeling-off and slippage of the composite layer from the substrate.

In the energy storage device according to an aspect of the present invention, it is preferable that the intermediate layer, a layer thickness D1 at the exposed portion be set to be greater than a layer thickness D2 at the non-exposed portion, and further, in the composite layer, an edge on a side facing the intermediate layer be located lower than the height of the surface of the exposed portion.

According to the energy storage device having the present configuration, the layer thickness D1 at the exposed portion is set to be greater than the layer thickness D2 at the non-exposed portion, and further, in the composite layer, the edge on the side facing the intermediate layer is located lower than the height of the surface of the exposed portion. Consequently, the intermediate layer is disposed so as to cover an edge of the composite layer. Thus, the stress generated in the drawn area is blocked by the intermediate layer by the time when the stress is transmitted to the composite layer, thereby securely suppressing the peeling-off and slippage of the composite layer from the substrate.

In the energy storage device according to an aspect of the present invention, it is preferable that the layer thickness D2 at the non-exposed portion be set to 30% to 80% of the layer thickness D1 at the exposed portion.

According to the energy storage device having the present configuration, the layer thickness D2 at the non-exposed portion is set to 30% to 80% of the layer thickness D1 at the exposed portion. Consequently, the stress generated in the drawn area is more effectively blocked by the intermediate layer, thereby securely suppressing the peeling-off and slippage of the composite layer from the substrate.

In the energy storage device according to an aspect of the present invention, it is preferable that in the intermediate layer, a projection width S1 from the composite layer toward the non-applied portion be set to 0.5 mm to 2.5 mm.

According to the energy storage device having the present configuration, in the intermediate layer, the projection width S1 from the composite layer toward the non-applied portion is set to 0.5 mm to 2.5 mm. Consequently, the stress generated in the drawn area can be satisfactorily reduced at an area in the projection width S1 of the composite layer, thereby securely suppressing the peeling-off and slippage of the composite layer from the substrate.

In the energy storage device according to an aspect of the present invention, it is preferable that the projection width S1 be set to 15% to 85% of a width S2 from an end of the drawn area to an end of the composite layer.

According to the energy storage device having the present configuration, the projection width S1 is set to 15% to 85% of the width S2 from the end of the drawn area to the end of the composite layer. Consequently, the stress generated in the drawn area can be securely reduced at an area in the projection width S1 of the intermediate layer, thereby preventing the peeling-off and slippage of the composite layer from the substrate.

In the energy storage device according to an aspect of the present invention, it is preferable that a peeling-off strength of the intermediate layer with respect to the substrate be greater than a peeling-off strength of the composite layer with respect to the intermediate layer.

According to the energy storage device having the present configuration, the peeling-off strength of the intermediate layer with respect to the substrate should be greater than the peeling-off strength of the composite layer with respect to the intermediate layer. Consequently, the intermediate layer functions as an adhesive layer between the substrate and the composite layer, thereby preventing the peeling-off and slippage of the composite layer from the substrate.

In the energy storage device according to an aspect of the present. invention, it is preferable that the peeling-off strength of the intermediate layer with respect to the substrate be 200 gf/cm or higher.

According to the energy storage device having the present configuration, the peeling-off strength of the intermediate layer with respect to the substrate is 200 gf/cm or higher. Consequently, it is possible to provide the practicable energy storage device in which the composite layer is hardly peeled off or slipped from the substrate.

In the energy storage device according to an aspect of the present invention, it is preferable that the intermediate layer be a buffer that alleviates a stress transmitted from the drawn area.

According to the energy storage device having the present configuration, the intermediate layer is the buffer that alleviates the stress transmitted from the drawn area. Consequently, the stress generated in the drawn area can be alleviated when it passes through the intermediate layer, thereby preventing peeling-off and slippage of the composite layer from the substrate.

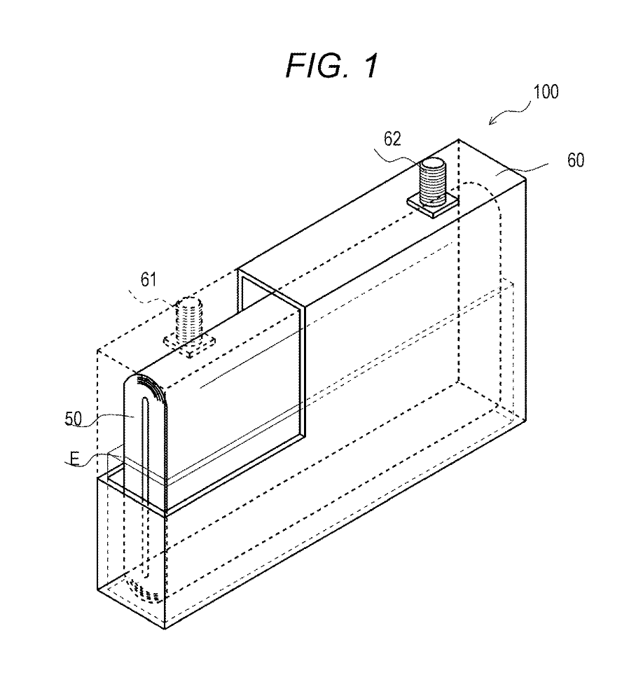

Explanation will be made below on embodiments with reference to FIGS. 1 to 6. In the embodiments below, an energy storage device is exemplified by a lithium ion battery. However, the present invention is not intended to be limited to the configuration described in the embodiments below or the drawings.

[Lithium Ion Battery]

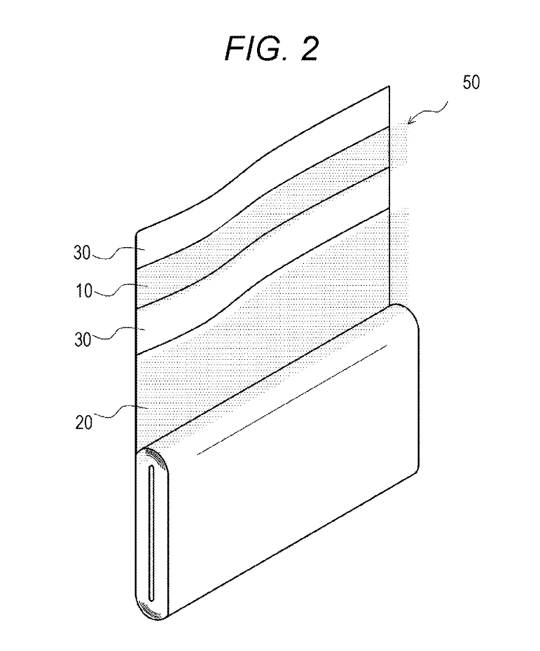

FIG. 1 is a partially cut-out perspective view, showing a lithium ion battery 100 in the present embodiment. FIG. 2 is a perspective view showing a power generating element 50 housed in a battery case 60 in the lithium ion battery 100 shown in FIG. 1. In FIG. 2. for the sake of easy explanation of the configuration of the power generating element 50, the power generating element 50 in a wound state is shown in a partly unwound state. Incidentally, FIGS. 1 and 2 each are schematic views, and therefore, the detailed configuration unnecessary for the explanation of the present invention is omitted.

As shown in FIG. 1, in the lithium ion battery 100, the power generating element 50 is housed in the battery case 60 serving as a casing provided with a positive electrode terminal 61 and a negative electrode terminal 62, and further, the battery case 60 is filled with an electrolyte solution E containing a non-aqueous electrolyte. As shown in FIG. 2, the power generating element 50 is obtained by winding a layered product formed by layering a separator 30, a positive electrode 10, a separator 30, and a negative electrode 20 in this order. In this layered product, the positive electrode 10 and the negative electrode 20 are separated from each other via the separator 30, and therefore, the positive electrode 10 and the negative electrode 20 are not brought into contact with each other even when the layered product is wound. Namely, the positive electrode 10 and the negative electrode 20 are physically insulated from each other. In the power generating element 50, the positive electrode 10 is connected to the positive electrode terminal 61, and further, the negative electrode 20 is connected to the negative electrode terminal 62. The electrolyte solution E, with which the battery case 60 is filled, is absorbed by the positive electrode 10, the negative electrode 20, and the separator 30 that form the power generating element 50, so that the power generating element 50 becomes wet. As a consequence, Li ions contained in the electrolyte solution E become movable between the positive electrode 10 and the negative electrode 20 via the separator 30. The filling amount of the electrolyte solution E in the battery case 60 is enough to allow at least the power generating element 50 to absorb the electrolyte solution E in a substantially completely wet state. However, the positive electrode 10 and the negative electrode 20 forming the power generating element 50 may change in volume during electric charging/discharging processes. In view of this, as shown in FIG. 1, it is desirable that the battery case 60 should be excessively filled with the electrolyte solution E to such an extent that a part of the power generating element 50 is soaked inside the battery case 60. The filling amount of the electrolyte solution E in the battery case 60 may be appropriately adjusted in consideration of the balance between the prevention of lack of the electrolyte solution in the power generating element 50 and pressure inside the battery case. A detailed description will be given below of the configuration of the lithium ion battery 100.

[Power Generating Element]

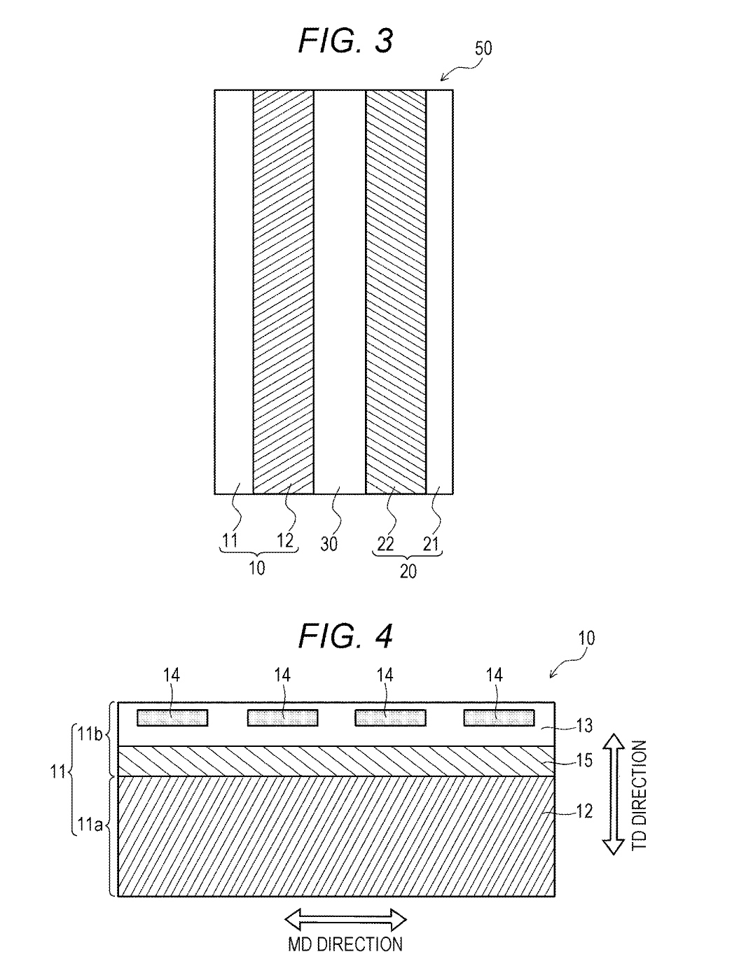

FIG. 3 is a cross-sectional view schematically showing the configuration of the power generating element 50. The power generating element 50 basically includes the positive electrode 10, the negative electrode 20, and the separator 30.

<Positive Electrode>

The positive electrode 10 includes a positive composite layer 12 formed on the surface of a positive electrode current collector (i.e., a positive electrode substrate) 11. The positive electrode current collector 11 is formed of a foil or film made of a conductive material. Examples of the conductive material include aluminum, titanium, nickel, tantalum, silver, copper, platinum, gold, iron, stainless steel, carbon, and a conductive polymer. A preferred mode of the positive electrode current collector 11 is an aluminum foil. A surface of an aluminum foil is coated with oxide (alumina), and therefore, it becomes stable. Furthermore, the aluminum foil is readily bent or wound. Thus, the aluminum foil is suitable for a member for a positive electrode for a lithium ion battery. The positive electrode current collector 11 may be subjected to surface treatment with other conductive materials. The thickness of the positive electrode current collector 11 ranges from 10 μm to 30 μm, and preferably, from 15 μm to 20 μm. If the thickness of the positive electrode current collector 11 is less than 10 μm, the mechanical strength of the positive electrode 10 may be insufficient. If the thickness of the positive electrode current collector 11 exceeds 30 μm, the entire capacity or weight of the lithium ion battery is increased, thereby decreasing packaging efficiency.

The positive composite layer 12 includes a positive active material and a binder. The positive active material can store or adsorb Li ions, and further, can discharge the Li ions. Examples of the positive active material include an olivine type lithium phosphate compound expressed by the general formula: LiMPO₄ (wherein M represents at least one kind selected from transit metals) and a spinel type lithium transit metal compound expressed by the general formula: LiMn₂O₄. Examples of the olivine type lithium phosphate compound include transit metal lithium phosphate compounds such as LiFePO₄, LiMnPO₄, LiNiPO₄, and LiCoPO₄. Among them, LiFePO₄ can be used suitably for the positive active material because it partly contains iron that abundantly exists as resources and it has an expected energy density equivalent to that of the conventional lithium ion battery. Alternatively, lithium transit metal oxide expressed by LiₓCo_{y}Ni_{z}Mn_{(1-y-z)}O₂ (wherein 0.95≦x≦1.2, 0.1≦y≦0.34, and 0<z, and 1-y-z>0) may be used as the positive active material. Examples of the positive active material are not limited to those listed herein.

The binder is adapted to bind the positive active material, and may be a hydrophilic binder or a hydrophobic binder. Examples of the hydrophilic binder include polyacrylic acids (PAA), carboxymethyl-cellulose (CMC), polyvinyl alcohol (PVA), polyethyleneoxide (PEO), and salts or derivatives of polymers thereof. The hydrophilic binders may be used alone or in combination of two or more kinds thereof. Examples of the hydrophobic binder include polyvinylidene fluoride (PVDF), polytetrafluoroethylene (PTFE), polyethylene (PE), polypropylene (PP), an ethylenepropylenedien terpolymer (EPDM), sulfonated ethylene propylene rubber, styrene-butadiene rubber (SBR), fluororubber, and salts or derivatives of polymers thereof. The above-described hydrophobic binders may be used alone or in combination of two or more kinds thereof.

In forming the positive composite layer 12 on the positive electrode current collector 11, a solvent is added to a mixture of a positive active material and a binder, followed by mixing and preparing, thus obtaining paste for the positive electrode. The solvent used for preparing the paste for the positive electrode is determined according to the kind of binder to be combined with the positive active material. In the case where the hydrophilic binder is used for preparing the paste for the positive electrode, water, alcohol, a soluble solvent such as an acetic acid, and the like are used as the solvent. In contrast, in the case where the hydrophobic binder is used, a lipophilic solvent such as N-methyl-2-pyrrolidone (NMP), xylene, or toluene is used as the solvent.

In order to enhance the conductivity of the positive electrode 10, a conductive additive may be added into the paste for the positive electrode. An electron conductive material that does not adversely influence battery performance is used as the conductive additive. Examples of the conductive additive include acetylene black, Ketjen black, carbon black, carbon whisker, carbon fiber, natural graphite, artificial graphite, metal powder, and conductive ceramics. The above-described conductive additives may be used alone or in combination of two or more kinds thereof.

The positive electrode current collector 11 may be coated with the paste for the positive electrode by a coating device such as a bar coater, a roll coater, a die coater, or a gravure coater. In the case where the viscosity of the paste is sufficiently small, the paste for the positive electrode may be sprayed onto the surface of the positive electrode current collector 11 by the use of an atomizer, followed by coating. The coated paste for the positive electrode is dried, and then, the solvent. contained in the paste is evaporated and removed. Thereafter, the positive electrode 10 is rolled in a predetermined thickness by a press machine or the like.

<Negative Electrode>

The negative electrode 20 includes a negative composite layer 22 formed on a negative electrode current collector 21. The material and thickness of the negative electrode current collector 21 are the same as those of the positive electrode current collector 11 used for the positive electrode 10, and therefore, the detailed explanation will be omitted.

The negative composite layer 22 includes a negative active material and a binder. The negative active material can store or adsorb Li ions, and further, can discharge the Li ions. Examples of the negative active material include hard carbon, soft carbon, graphite, and lithium titanate having a spinel type crystalline structure.

The binder is adapted to bind the negative active material, and may be a hydrophilic binder or a hydrophobic binder. The kind and selection of the binder are the same as those of the binder used for the positive electrode 10, and therefore, the detailed explanation will be omitted.

In forming the negative composite layer 22 on the negative electrode current collector 21, a solvent is added to a mixture of a negative active material and a binder, followed by mixing and preparing, thus obtaining paste for the negative electrode. The solvent used for preparing the paste for the negative electrode is determined according to the kind of binder to be combined with the negative active material. This is the same as the solvent used for preparing the paste for the positive electrode, and therefore, the detailed explanation will be omitted.

The surface of the negative electrode current collector 21 is coated with the paste for the negative electrode by the same coating device as that used for coating the surface of the positive electrode current collector 11 with the paste for the positive electrode, and therefore, the detailed explanation will be omitted.

<Separator>

The separator 30 is made of a porous material that can separate the positive electrode 10 and the negative electrode 20 from each other and has the function of allowing the nonaqueous electrolyte contained in the electrolyte solution E to permeate. The porous material should preferably have performance of 150 sec./cc or more as air-permeability to be measured in conformity with JIS P 8117 so as to satisfactorily secure suction capacity of the electrolyte solution E. Examples of materials of the separator 30 include polyolefin-based resins such as polyethylene (PE) and polypropylene (PP), polyester-based resins such as polyethylene terephthalate (PET) and polybutylene terephthalate (PBT), polyacrylonitrile-based resins, polyphenylene sulfide-based resins, polyimide-based resins, and fluorine resins. The separator 30 may be subjected to surface treatment with a surface-active agent.

[Electrolyte Solution]

The electrolyte solution E that mediates the movement of the Li ions is obtained by dissolving an electrolytic salt in a nonaqueous solvent. Examples of the nonaqueous solvent include ring-carbonates such as propylene carbonate, ethylene carbonate, butylene carbonate, chloroethylene carbonate, and vinylene carbonate; ring-esters such as γ-butyrolactone and γ-valerolactone; and chain-carbonates such as dimethyl carbonate, diethyl carbonate, and ethylmethyl carbonate. These nonaqueus solvents may be used singly or in combination of two or more kinds thereof. Li ion salts are used as the electrolytic salt, and examples thereof include LiPF₆, LiClO₄, LiBF₄, LiAsF₆, and LiSbF₆. These electrolytic salts may be used alone or in combination of two or more kinds thereof.

[Layered Structure of Electrodes]

In the lithium ion battery 100, the layered structure of the electrodes is contrived to suppress the peeling-off and slippage of the composite layer from the substrate. Then, explanation will be made on the layered structure of the electrodes in the lithium ion battery 100 by way of the positive electrode 10. FIG. 4 is a plan view schematically showing the configuration of the positive electrode 10 for the lithium ion battery 100. The positive electrode 10 is provided with the positive composite layer 12 on a center side 11a of the positive electrode current collector 11 serving as the substrate. The positive composite layer 12 is obtained with the application of a past for a positive electrode paste including a positive active material, a binder, and a solvent in mixture. An end side 11b of the positive electrode current collector 11 is kept as a non-applied portion 13, to at least a part of which the paste for the positive electrode is not applied, to be connected to a terminal or the like, not shown. Drawn portions 14 serving as drawn areas in a roiling process are formed at the non-applied portion 13 so as to prevent any curve of the positive electrode 10. The drawn portions 14 can be apparently distinguished from surrounding non-drawn portions that are not subjected to the rolling process because the surface roughness Ra is different from that of the surrounding non-drawn portions. For example, when the non-applied portion 13 is rolled, the surface roughness Ra of the drawn portions 14 is different by 10% or more from that of the other portions. As a consequence, the drawn portions 14 are recognized as a portion at which areas having different surface roughnesses Ra are sequentially arranged. The surface roughness Ra is calculated by, for example, measuring the surface roughness at five arbitrary points within 1 mm² of a foil drawn area, followed by averaging the resultant values. The same measurement is carried out at a non-drawn area. Thus, the surface roughnesses are compared with each other. Incidentally, the drawn portions 14 in FIG. 4 are formed at predetermined intervals along the longitudinal direction (i.e., an MD direction) of the positive electrode current. collector 11 by way of one example. However, the drawn portions 14 may be continuously formed in a belt-like fashion. In the end, the drawn portions 14 are simply required to be formed at at least one portion of the non-applied portion 13.

When the drawn portions 14 are formed at the non-applied portion 13, a stress caused by the rolling process is produced around the drawn portions 14. When this stress is transmitted toward an end indicated by the center side 11a of the positive electrode current collector 11, a joint interface between the positive electrode current collector 11 and the positive composite layer 12 accidentally peels off, thereby possibly causing the positive composite layer 12 to slip from the positive electrode current collector 11. In view of this, the present inventors earnestly studied to suppress the peeling-off and slippage of the positive composite layer 12 from the positive electrode current collector 11. As a result, they have found that the formation of an intermediate layer 15 between the drawn portions 14 and the positive composite layer 12 can reduce, at the intermediate layer 15, the stress generated at the drawn portions 14 so as to make it difficult to influence the positive composite layer 12.

The intermediate layer 15 is formed in such a manner as to be brought into contact with both of the positive electrode current collector 11 (including the non-applied portion 13) and the positive composite layer 12 at the same time. Moreover, the peeling-off strength of the intermediate layer 15 with respect to the positive electrode current collector 11 is set to be greater than that of the positive composite layer 12 with respect to the intermediate layer 15. For example, the peeling-off strength of the intermediate layer 15 with respect to the positive electrode current collector 11 is set to 200 gf/cm or more, preferably, 230 gf/cm more: in contrast, the peeling-off strength of the positive composite layer 12 with respect to the intermediate layer 15 is set to 90 gf/cm to 600 gf/cm, preferably, 130 gf/cm to 350 gf/cm. In this case, the intermediate layer 15 functions as a buffer for alleviating the stress generated at the drawn portion 14. Therefore, the stress generated at the drawn portion 14 is designed to be alleviated through the intermediate layer 15. Consequently, the stress generated at the drawn portion 14 cannot act directly on the positive composite layer 12, and thus, cannot reach the positive composite layer 12. Alternatively, even if the stress generated at the drawn portion 14 reaches the positive composite layer 12, it becomes to be alleviated to some extent through the intermediate layer 15. Consequently, it is possible to effectively prevent or suppress the peeling-off and slippage of the positive composite layer 12 from the positive electrode current collector 11. In an example of a measuring method of the peeling-off strength, a mending tape or like having a width of 20 mm is stuck to a surface whose peeling-off strength is intended to be measured, followed by pulling in a direction of 180°. Furthermore, a commercially available surface cutting tester may be used (exemplary measurement condition: as a cutting edge movement speed, a horizontal speed of 1 μm/sec to 10 μm/sec and a vertical speed of 0.1 μm/sec to 1 μm/sec; and a measurement length of 1 mm to 10 mm).

The intermediate layer 15 is prepared by including a material having damping characteristics such as polyvinylidene fluoride, chitosan and its derivatives, cellulose and its derivatives, an acrylic resin, polyimide, or polyethylene oxide in such a manner as to function as the buffer. Moreover, the intermediate layer 15 may partly charge or discharge the lithium ion battery 100. In this case, the intermediate layer 15 is prepared by including a positive active material and a binder. In order to satisfy the above-described conditions for the peeling-off strength, a binder having an adhesiveness greater than that of the binder for use in the positive composite layer 12 is selected as a binder for use in the intermediate layer 15. For example, in the case where polyacrylic acid (PAA) as a hydrophilic binder is used as the binder for the positive composite layer 12, it is preferable that a hydrophobic binder such as polyvinylidene fluoride (PVDF), polytetrafluoroethylene (PTFE), or polyethylene(PE) should be used the binder for the intermediate layer 15. A positive active material similar to that used for the positive composite layer 12 may be used as the positive active material for the intermediate layer 15.

The configuration of the electrode provided with the intermediate layer 15 in the energy storage device will be described by way of two typical embodiments. Here, although the electrode is explained by way of the positive electrode 10 also in the embodiments below, the negative electrode 20 may be similarly configured.

### First Embodiment

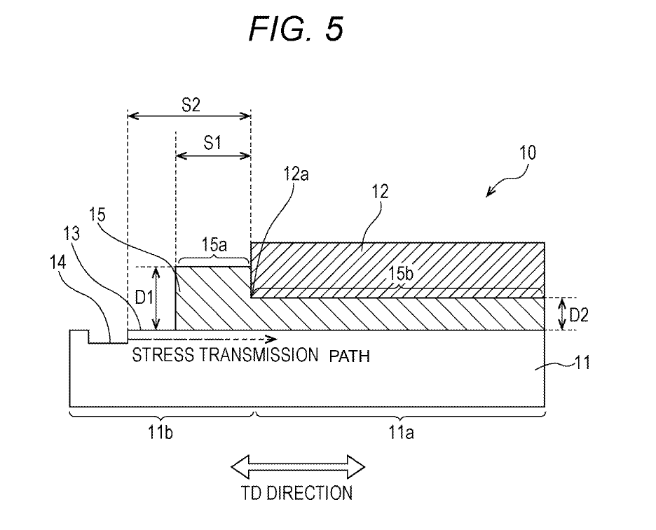

FIG. 5 is a cross-sectional view schematically showing the configuration of a positive electrode 10 in a first embodiment. FIG. 5 shows the cross section of the positive electrode 10 in a widthwise direction (i.e., a TD direction). In the positive electrode 10 in the first embodiment, a positive composite layer 12 is disposed on a center side 11a of a positive electrode current collector 11, wherein an intermediate layer 15 is interposed between the positive electrode current collector 11 and the positive composite layer 12 in a layered structure. Here, the intermediate layer 15 is disposed in such a. manner that its edge projects from the positive composite layer 12. Consequently, the intermediate layer 15 includes a single exposed portion 15a formed between a drawn portion 14 and the positive composite layer 12 and a non-exposed portion 15b formed under the positive composite layer 12, as viewed from the top. Specifically, a part of the intermediate layer 15 intrudes under the positive composite layer 12 between the drawn portion 14 and the positive composite layer 12. As a consequence, the intermediate layer 15 is formed in such a manner as to be brought into contact with a transmission path for releasing a stress generated at the drawn portion 14. The stress is reduced by the intermediate layer 15, thereby effectively suppressing the peeling-off and slippage of the positive composite layer 12 from the positive electrode current collector 11. The exposed portion 15a of the intermediate layer may lean in a manufacturing process, like a moderate mountain. Even with such a shape, the effect can be achieved. Here, the viscosity of the intermediate layer is adjusted, so that the shape of the exposed portion of the intermediate layer can be controlled. An increase in viscosity can vary a moderate mountain shape to a sharp shape.

In FIG. 5, a projection width S1 of the intermediate layer 15 from the positive composite layer 12 toward the non-applied portion is set to 0.5 mm to 2.5 mm, preferably 1.0 mm to 2.0 mm. If the projection width S1 is set. to less than 0.5 mm, there is a fear that the stress generated at the drawn portion 14 cannot be satisfactorily reduced at the intermediate layer 15. Moreover, insufficient secureness of the projection width unfavorably increases the possibility that a composite end projects from the intermediate layer during composite application. Thus, it is not preferable that the projection width S1 is set to less than 0.5 mm. In contrast, even if the projection width S1 is set to more than 2.5 mm, peeling-off suppressing effect is not varied. Additionally, if a projecting portion is too large, a space at which foil drawing is effectively performed is reduced. From the viewpoint of a material cost, the projection width S1 is preferably set to 2.5 mm or less. In addition, the projection width S1 is set to 15% to 85% of a width S2 from the end of the drawn area to an end of the composite layer, preferably, is set to 50% to 80%. By setting the projection width S1 within the above-described range, the stress generated at the drawn portion 14 can be securely reduced in an area having the projection width S1 at the intermediate layer 15, thereby preventing the peeling-off and slippage of the positive composite layer 12 from the positive electrode current collector 11. Incidentally, the width S2 should be preferably 4.0 mm or less. This is because if the width S2 is too narrow, the intermediate layer is brought into contact with the drawn portion while the non-applied portion is rolled, thereby causing the composite to be peeled off. Furthermore, since a curve reducing effect may be reduced, the above-described range is desired.

Moreover, in FIG. 5, a thickness D1 of a layer at the exposed portion 15a of the intermediate layer 15 is set to be greater than a thickness D2 of a layer at the non-exposed portion 15b, and further, an edge 12a of the positive composite layer 12 on a side facing the intermediate layer 15 is located lower than the height of the surface of the exposed portion 15a. Specifically, the thickness D2 of the layer at the non-exposed portion 15b is set to 30% to 80%, preferably 40% to 65%, of the thickness D1 of the layer at the exposed portion 15a. In the case of less than 30%, there is a high possibility that the active material is brought. into direct contact with a foil through the intermediate layer, thereby degrading the peeling-off suppressing effect. In contrast, in the case of more than 80%, the filling density of the active material is small (due to a weak pressing force), thereby degrading the battery performance. In this case, the intermediate layer 15 is disposed in such a mode as to cover the edge 12a of the positive composite layer 12. Therefore, the stress generated at the drawn portion 14 is blocked by the intermediate layer 15 until it is transmitted to the positive composite layer 12, thus securely suppressing the peeling-off and slippage of the positive composite layer 12 from positive electrode current collector 11.

As a consequence, in the first embodiment, the curve of the positive electrode 10 in the rolling process is prevented while suppressing the peeling-off and slippage of the positive composite layer 12 from the positive electrode current collector 11, resulting in the manufacture of the lithium ion battery 100 with high quality. Incidentally, the thickness D1 of the layer at the exposed portion 15a of the intermediate layer 15 may be greatest or an average thickness of the exposed portion 15a of the intermediate layer 15. In the case of the average thickness, naturally, the average thickness need be set to be greater than the thickness D2 of the layer at the non-exposed portion 15b.

### Second Embodiment

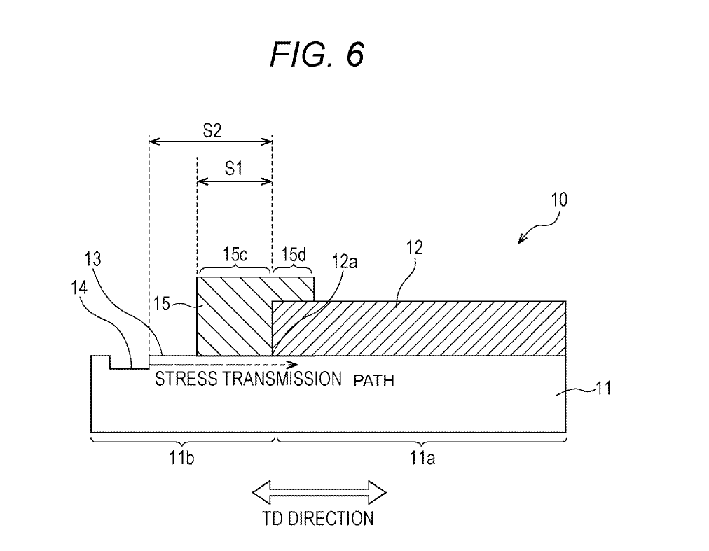

FIG. 6 is a cross-sectional view schematically showing the configuration of a positive electrode 10 in a second embodiment, FIG. 6 shows the cross section of the positive electrode 10 in a widthwise direction (i.e., a TD direction). In the positive electrode 10 in the second embodiment, a positive composite layer 12 is disposed on a center side 11a of a positive electrode current collector 11, and furthermore, an intermediate layer 15 is formed from an end 11b of the positive electrode current collector 11 to an edge 12a of the positive composite layer 12. The intermediate layer 15 includes a single layer 15c formed directly on the positive electrode current collector 11 and an over-layer portion 15d over layered on the positive composite layer 12. The single layer 15c is a portion corresponding to the exposed portion 15a in the first embodiment. The intermediate layer 15 shown herein may be an insulating layer.

In FIG. 6, a projection width S1 (corresponding to the width of the single layer 15c) of the intermediate layer 15 from the positive composite layer 12 toward a non-applied portion and a width S2 of a non-applied portion 13 should be preferably set within ranges similar to those of the projection width S1 and the width S2 in the first embodiment. In this manner, a stress generated at a drawn portion 14 can be sufficiently reduced at the intermediate layer 15 while the capacity of a lithium ion battery 100 can be satisfactorily secured.

Also in the second embodiment, the intermediate layer 15 exists in such a manner as to be brought into contact with a transmission path for the stress generated at the drawn portion 14, so that the stress can be reduced at the intermediate layer 15, thus suppressing the peeling-off and slippage of the positive composite layer 12 from the positive electrode current collector 11. In the positive electrode 10, the positive composite layer 12 is formed on the positive electrode current collector 11, and further, the intermediate layer 15 is formed so as to cover a part of the positive composite layer 12. Consequently, the battery can be manufactured only by adding an intermediate layer forming process to a process for manufacturing a conventional positive electrode 10 without any intermediate layer 15.

Thus, in the second embodiment, it is possible to easily manufacture the lithium ion battery 100 with high quality without largely modifying manufacturing facility or increasing a cost.

Here, in both the first embodiment and the second embodiment, the drawn portion 14 can be identified by, for example, a pressure scar (a pressure mark). In the positive or negative electrode current collector 11, an edge in the area 11b (an end opposite to a side on which a composite layer is applied) may be drawn (rolled). The function and effect according to the present invention can be expected also in a case where a separator is bonded onto an electrode (i.e., a bonding separator), and in a case where a so-called “overcoating” is made (i.e., an electrode s coated with an insulating layer, more specifically, a composite layer applied onto a current collector is fully or partly coated with an insulating layer).

The present invention is applicable to a secondary battery (such as a lithium ion battery) used as a power source for vehicle for an electric vehicle (EV), a hybrid electric vehicle (HEV), or a plug-in hybrid electric vehicle (PHEV), and furthermore, is applicable to a secondary battery (such as a lithium ion battery) used as a drive power source for a mobile communication terminal such as a mobile phone or a smartphone, or an information terminal such as a tablet computer or a laptop computer.

What is claimed is:

1. An energy storage device comprising:
an electrode including a composite layer formed by applying a composite directly or indirectly onto a substrate and a non-applied portion, onto which the composite is not applied; and
a separator layered on the electrode to face the composite layer,
wherein a drawn area is formed in at least a part of the non-applied portion, and. an intermediate layer is interposed at least between the drawn. area and the composite layer.

2. The energy storage device according to claim 1, wherein the intermediate layer includes an exposed portion that singly exists at least between the drawn area and the composite layer, and a non-exposed portion that exists under the composite layer.

3. The energy storage device according to claim 2, wherein in the intermediate layer, a layer thickness D1 at the exposed portion is set to be greater than a layer thickness D2 at the non-exposed portion, and in the composite layer, an edge on a side facing the intermediate layer is located lower than the height of the surface of the exposed portion.

4. The energy storage device according to claim 3, wherein the layer thickness D2 at the non-exposed portion is set to 30% to 80% of the layer thickness D1 at the exposed portion.

5. The energy storage device according to claim 1, wherein in the intermediate layer, a projection width S1 from the composite layer toward the non-applied portion is set to 0.5 mm to 2.5 mm.

6. The energy storage device according to claim 5, wherein the projection width S1 is set to 15% to 85% of a width S2 from an end of the drawn area to an end of the composite layer.

7. The energy storage device according to claim 1, wherein a peeling-off strength of the intermediate layer with respect to the substrate is greater than a peeling-off strength of the composite layer with respect to the intermediate layer.

8. The energy storage device according to claim 1, wherein the peeling-off strength of the intermediate layer with respect to the substrate is 200 gf/cm or higher.

9. The energy storage device according to claim 1, wherein the intermediate layer is a buffer that alleviates a stress transmitted from the drawn area.

10. The energy storage device according to claim 1, wherein the intermediate layer includes an insulating exposed portion that exists only between the drawn area and the composite layer.

11. The energy storage device according to claim 1, wherein the separator is a bonding separator that is bonded to the electrode.

12. The energy storage device according to claim 1, wherein the electrode is an electrode coated with an insulating layer.
